(19) United States
(12) Patent Application Publication
(10) Pub. No.: US 2020/0355051 A1
(43) Pub. Date: Nov. 12, 2020

(54) METHODS FOR RECOVERING PETROLEUM THAT INCLUDE USING EXOTHERMIC REACTIONS IN AQUEOUS ZONES OF RESERVOIRS

(71) Applicant: Saudi Arabian Oil Company, Dhahran (SA)

(72) Inventor: Ayman R. Al-Nakhli, Dammam (SA)

(73) Assignee: Saudi Arabian Oil Company, Dhahran (SA)

(21) Appl. No.: 16/405,505

(22) Filed: May 7, 2019

(51) Int. Cl. E21B 43/24; E21B 43/20; C09K 8/592

(52) U.S. Cl. CPC E21B 43/24; C09K 8/592; E21B 43/20

(57) ABSTRACT

According to one or more embodiments presently described, petroleum may be recovered from a sub-surface reservoir by a method that may include passing one or more exothermic reaction components into an aqueous zone of the sub-surface reservoir in a geological formation. The reservoir may comprise a petroleum zone including petroleum and an aqueous zone including water. The petroleum zone and the aqueous zone may be separated, at least partially, by a tar zone. The method may further include reacting the one or more exothermic reaction components to increase the temperature, pressure, or both, in the aqueous zone to reduce the viscosity of the tar zone such that pressure in the aqueous zone may drive extraction of petroleum from the petroleum zone to the surface.

### BACKGROUND

### Field

The present disclosure relates natural resource extraction and, more specifically, to methods for recovering petroleum from sub-surface geological formations.

### Technical Background

Tar zones, which may have little or no permeability, may act as a barrier that hinders flow of water in a reservoir. For example, tar mats are extra-heavy bitumen that occur between aquifers and overlaying oil columns. They seal either partially or completely an oil reservoir from its aquifer, reducing aquifer support. Such tar zones may also form a barrier that physically isolates petroleum producing zones from injection water. As a result of this barrier, the reservoir pressure will decrease and cause an increasing number of dead wells and declining productivity.

### BRIEF SUMMARY

As such, methods are needed that reduce the problems associated with tar zones. These methods may allow for additional petroleum to be recovered from existing wells. In one or more embodiments, the negative effects of tar zones are reduced or eliminated by the introduction of exothermic reaction components into an aqueous zone (that includes water) that is near to or adjacent the tar zone. Such exothermic reactants may increase the temperature, pressure, or both, in the aqueous zone which may physically mobilize the tar. For example, the temperature or pressure may reduce the viscosity of the tar, allowing for puncturing of the tar layer and fluid communication between the aqueous zone and the petroleum in the reservoir. In other embodiments, the reduction in viscosity of the tar may allow for pressure to be exerted on the petroleum by the water in the aqueous zone by pushing on the tar zone. Such methods may allow for petroleum recovery in a previously spent well that had insufficient pressure on the petroleum within the reservoir.

According to one or more embodiments of the present disclosure, petroleum may be recovered from a sub-surface reservoir by a method that may comprise passing one or more exothermic reaction components into an aqueous zone of the sub-surface reservoir in a geological formation. The reservoir may comprise the aqueous zone, a petroleum zone comprising petroleum, and an aqueous zone comprising water. The petroleum zone and the aqueous zone may be separated, at least partially, by a tar zone. The method may further comprise reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface.

According to one or more additional embodiments of the present disclosure, petroleum may be recovered from a sub-surface reservoir by a method that may comprise passing one or more exothermic reaction components through an injection well into an aqueous zone of the sub-surface reservoir in a geological formation. The reservoir may comprise the aqueous zone, a petroleum zone comprising petroleum, and an aqueous zone comprising water. The petroleum zone and the aqueous zone may be separated, at least partially, by a tar zone. The method may further comprise reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface through an extraction well.

According to one or more yet additional embodiments of the present disclosure, petroleum may be recovered from a sub-surface reservoir by a method that may comprise passing one or more exothermic reaction components into an aqueous zone of the sub-surface reservoir in a geological formation. The reservoir may comprise the aqueous zone, a petroleum zone comprising petroleum, and an aqueous zone comprising water. The petroleum zone and the aqueous zone may be separated, at least partially, by a tar zone. The method may further comprise reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface. The one or more exothermic reaction components may comprise an ammonium-containing compound and a nitrite-containing compound. The exothermic reaction may be activated by an acid precursor.

Additional features and advantages of the technology described in this disclosure will be set forth in the detailed description that follows, and in part will be readily apparent to those skilled in the art from the description or recognized by practicing the technology as described in this disclosure, including the detailed description that follows, the claims, as well as the appended drawings.

### BRIEF DESCRIPTION OF THE DRAWINGS

The following detailed description of specific embodiments of the present disclosure can be best understood when read in conjunction with the following drawings, in which:

FIG. 1 graphically depicts the relationship between viscosity and temperature of an asphaltene sample in the presence of an exothermic reaction, according to one or more embodiments presently described;

FIG. 2 graphically depicts the relationship between temperature, pressure, and time in minutes (min) during an exothermic reaction, according to one or more embodiments presently described;

FIG. 3 graphically depicts the relationship between temperature, pressure, and time during an exothermic reaction, according to one or more embodiments presently described;

FIG. 4 graphically depicts the relationship between temperature, pressure, and time during an exothermic reaction, according to one or more embodiments presently described;

FIG. 5 graphically depicts the relationship between temperature, pressure, and time during an exothermic reaction, according to one or more embodiments presently described;

FIG. 6 graphically depicts the relationship between the final achieved temperature, final achieved pressure, and initial pressure of an exothermic reaction, according to one or more embodiments presently described;

FIG. 7 graphically depicts the relationship between the final achieved temperature, final achieved pressure, and concentration of reactants of an exothermic reaction, according to one or more embodiments presently described;

FIG. 8 graphically depicts the relationship between the rate of oil production, rate of fluid injection, and time during oil recovery processes, according to one or more embodiments presently described; and

FIG. 9 graphically depicts the relationship between the pH of the exothermic reaction components and the temperature required to trigger the exothermic reaction, according to one or more embodiments presently described.

### DETAILED DESCRIPTION

Described in this disclosure are methods for recovering petroleum from a sub-surface reservoir. Generally, a geological formation (sometimes referred to presently as a “formation”) may at least partially define the bounds of a reservoir containing at least petroleum. For example the reservoir may be a void, which at least partially contains petroleum, within a rock formation. “Sub-surface” refers to the position of the reservoir as being below the Earth's surface. This includes below the surface of both terrestrial and water covered geography. The formation may be made of rock materials such as, without limitation, sedimentary rock, metamorphic rock, or volcanic rock.

In one or more embodiments, the reservoir may include at least a petroleum zone, an aqueous zone, and a tar zone. The petroleum zone includes petroleum, the aqueous zone includes water, and the tar zone includes tar. These respective zones may include at least 50 weight percent (wt. %), 75 wt. %, 90 wt. %, 95 wt. %, 99 wt. %, or even 100 wt. % of petroleum, water, or tar, respectively. The petroleum zone may be in communication with an extraction well which leads to the surface. The aqueous zone may be in communication with an injection well. As presently described, petroleum may refer to any crude hydrocarbon material such as, without limitation, various grades of crude oil or natural gas. The petroleum may be originally present in a sub-surface reservoir. However, it should be appreciated that the presently described technology may be applicable for the extraction of non-petroleum materials. Tar, as described presently, refers to a relatively viscous mixed hydrocarbon material which may include asphaltenes. Tar, in one or more embodiments, may have a viscosity of at least 15,000 Pascal seconds (Pa s) at 20 degrees Celsius (° C.), or even at least 25,000 Pa s at 20° C., such as about 30,000 Pa s at 20° C.

In some embodiments, the aqueous zone may comprise a naturally occurring aquafer. In some embodiments, all of the water in the aqueous zone is aquafer water. Such aquafers, if the tar zone were not present, may cause increased pressure to form in the petroleum zone and push the petroleum in the petroleum zone to the surface. That is, where a tar zone is not present or has been treated by the processes presently described, pressure in the aquafer may cause added pressure on the petroleum, pushing it to the surface through an extraction well. In additional embodiments, the aqueous zone may include water that was pumped into the formation through an injection well. In such embodiments, water pumped through the injection well into the aqueous zone may include all of the water in the aqueous zone (where no natural aquafer was present) or may include only a portion of the water in the aqueous zone (where additional water is pumped into a naturally occurring aquafer). Such pumping of water into the aqueous zone may increase pressure in the aqueous zone, effecting pressure on the petroleum zone when tar is not present or is mobilized by the presently disclosed processes. In some embodiments, the aqueous zone prior to introduction of the exothermic reactants may have a greater pressure than the petroleum zone. For example, the pressure in the aqueous zone may be sufficient to push petroleum to the surface through the extraction well if not for the existence of the tar zone.

In the presently described embodiments, prior to introduction of the exothermic reaction components into the aqueous zone, the petroleum zone and the aqueous zone are separated, at least partially, by the tar zone. For example, in some embodiments the tar zone may act as a physical barrier between the aqueous zone and the petroleum zone. In such embodiments, water from the aqueous zone and the petroleum from the petroleum zone may be in direct contact with the tar in the tar zone, but be physically isolated from one another and not in direct contact with one another. In additional embodiments, some water from the aqueous zone may be in contact with petroleum from the petroleum zone. However, in such embodiments, most of the area where petroleum and water would be in direct contact includes tar of the tar zone. In such embodiments, while some direct contact between the water and the petroleum may be present, the existence of the tar inhibits pressure in the aqueous zone from effecting sufficient pressure on the petroleum zone such that the greater pressure in the water in the aqueous zone may not translate into substantially increased pressure in the petroleum zone as to allow for extraction of the petroleum. In additional embodiments, tar zones may isolate only a portion of petroleum in a formation.

In embodiments of the present disclosure, one or more exothermic reactants are passed into the aqueous zone. The one or more exothermic chemical reactants may be passed into the aqueous zone through an injection well. The one or more exothermic reaction components may be reacted to increase the temperature, pressure, or both, in the aqueous zone. The exothermic reaction may take place in the subterranean formation. Such a reaction may reduce the viscosity of the tar zone since the tar zone is in contact with the aqueous zone that is heated. When the viscosity of the tar in the tar zone is reduced, pressure in the aqueous zone may drive extraction of petroleum from the petroleum zone to the surface (even if there is not physical direct contact between the aqueous zone and the petroleum zone). It is believed that the reduction in viscosity of the tar may allow for the pressure of the aqueous zone to be translated to the petroleum zone. In such embodiments, the aqueous zone and the petroleum zone may not be in direct contact with one another, but the tar zone may no longer substantially restrict pressure in the water from effecting pressure on the petroleum. In additional embodiment, the reaction may allow for the water to directly contact the petroleum to pressurize the petroleum. For example, the reaction may cause forces that break up or puncture the tar zone, allowing for fluid communication of water from the aqueous zone across the tar zone. For example, gas produced in the reaction may cause a propulsive force on the tar zone which punctures the tar zone. On the other hand, in circumstances where the viscosity remains relatively great in the tar zone (for example, when temperature, pressure, or both are not increased in the aqueous zone), the tar may block the pressure of the water from pushing on the petroleum.

According to one or more embodiments, the temperature, pressure, or both, of the aqueous zone may be increased adjacent to the tar zone due to the exothermic reaction. By nature of the reaction being exothermic, heat will be produced and at least local temperature in the aqueous zone may increase. Additionally, pressure may be increased in the aqueous zone by formation of gases by the exothermic reaction. For example, nitrogen gas may be a product of the reaction and cause increased pressure buildup on the aqueous zone of the geological formation. It is contemplated that temperatures and pressures as great as 600 (degrees Fahrenheit) ° F. and 5,000 pounds per square inch (psi), respectively, may be present in the aqueous zone during and after the exothermic reaction. For example, the exothermic reaction may produce temperatures of at least 200° F., at least 300° F., at least 400° F., or even at least 500° F. in the aqueous zone. In additional embodiments, the pressure in the aqueous zone may be at least 2000 psi, at least 3000 psi, at least 4000 psi, at least 6000 psi, at least 10,000 psi, at least 15,000 psi, or even at least 20,000 psi.

In additional embodiments, one or more exothermic reactants present in the aqueous zone may penetrate into the tar zone and become mixed into the tar. In such embodiments, temperature may be directly raised in the tar zone by exothermic reaction, and tar may be mobilized by reactant gas formation.

The viscosity of the tar in the tar zone may be reduced due to the heating of the aqueous zone. For example, the viscosity of the tar in tar zone may be reduced to less than or equal to 3,000 centipoise (cP), less than or equal to 2,750 cP, less than or equal to 2, 500 cP, less than or equal to 2,250 cP, less than or equal to 2,000 cP, less than or equal to 1,750 cP, less than or equal to 1,500 cP, less than or equal to 1,750 cP, less than or equal to 1,500 cP, less than or equal to 1,250 cP, less than or equal to 1,000 cP, less than or equal to 900 cP, less than or equal to 800 cP, less than or equal to 700 cP, less than or equal to 600 cP, less than or equal to 500 cP, less than or equal to 400 cP, less than or equal to 300 cP, or even less than or equal to 200 cP. For example, tar having a temperature of greater than 200° F. may have a viscosity less than 1,000 cP, with viscosity greatly reduced at temperatures as great as 600° F.

In one or more embodiments, the aqueous zone, in which the exothermic reaction may proceed, may comprise one or more exothermic reaction components. As presently described, the one or more exothermic reaction components may refer to any one or more chemicals which can react downhole in the aqueous zone in an exothermic chemical reaction. The exothermic reaction may be triggered by one or more additional reactants or catalysts, or may be triggered by exposure to a particular temperature. For example, the aqueous zone may further comprise an acid precursor that activates the exothermic reaction or the reaction may be triggered by increased downhole temperature as compared with surface temperatures.

In one embodiment, the exothermic reaction components include an ammonium-containing compound and a nitrite-containing compound. In some embodiments of the present disclosure, the ammonium-containing compound is NH₄Cl and the nitrite-containing compound is NaNO₂. In some of the presently disclosed embodiments, the acid precursor is triacetin.

In embodiments where the aqueous zone includes an acid precursor, the acid precursor may be operable to trigger an exothermic reaction that consumes or converts one or more of the exothermic reaction components. The exothermic reaction component may be operable to generate heat and pressure. The acid precursor may be any acid that releases hydrogen ions to trigger the reaction of the one or more exothermic reaction components. Contemplated acid precursors include triacetin (1,2,3-triacetoxypropane), methyl acetate, HCl, and acetic acid. In at least one embodiment, the acid precursor is triacetin. In at least another embodiment, the acid precursor is acetic acid.

In additional embodiments, the one or more exothermic reaction components may include one or more redox reactants (that is, reduction/oxidation reactants) that exothermically react to produce heat and increase pressure. Suitable exothermic reaction components presently contemplated include urea, sodium hypochlorite, ammonium-containing compounds, and nitrite-containing compounds. In at least one embodiment of the present disclosure, the exothermic reaction component includes ammonium-containing compounds. Ammonium-containing compounds may include ammonium chloride, ammonium bromide, ammonium nitrate, ammonium sulfate, ammonium carbonate, and ammonium hydroxide.

In at least one embodiment, the exothermic reaction component may include nitrite-containing compounds. Nitrite-containing compounds may include sodium nitrite and potassium nitrite. In at least one embodiment, the exothermic reaction component includes both ammonium-containing compounds and nitrite-containing compounds. In at least one embodiment, the ammonium-containing compound is ammonium chloride, NH₄Cl. In at least one embodiment, the nitrite-containing compound is sodium nitrite, NaNO₂.

In one or more embodiments of the present disclosure, the exothermic reaction components include two redox reactants: NH₄Cl and NaNO₂, which react according to the following formula:

NH₄Cl+NaNO₂→N₂+NaCl+2H₂O+heat

In a reaction of the exothermic reaction components according to the previous equation, generated gas (nitrogen) and heat contribute to the reduction of the viscosity and physical mobilization of the tar in the tar zone, effectively unblocking the effects of pressure of the aqueous zone on the petroleum zone.

In at least one embodiment of the present disclosure, the acid precursor triggers the exothermic reaction component to react by releasing hydrogen ions. In additional embodiments, the exothermic reaction component is triggered by heat. For example, the exothermic reaction may be activated by downhole temperatures in the aqueous zone reaching a temperature greater than or equal to 120° F., at which time the reaction of the redox reactants may be triggered. In at least one embodiment, the reaction of the redox reactants is triggered by temperature in the absence of the acid precursor.

In at least one additional embodiment, the exothermic reaction component is triggered by acidic conditions in the aqueous zone following basic conditions. For example, a base may be added to the aqueous zone of the present disclosure to adjust the pH to between 9 and 12. In at least one embodiment, the base is potassium hydroxide. The base may be injected into the aqueous zone. Following the injection of the base, an acid precursor may be injected to lessen the pH. For example, acid precursor may lessen the pH to less than 9, less than 8, less than 7, or even less than 6. In some embodiments, when the pH is less than 6, the reaction of the redox reactants is triggered. The activation pH may also be affected by the temperature. For example, in one or more embodiments, the reaction of the redox reactants may be triggered when the pH is less than 9 and the temperature is greater than or equal to 185° F., when the pH is less than 8 and the temperature is greater than or equal to 150° F., when the pH is less than 7 and the temperature is greater than or equal to 135° F., or even when the pH is less than 6 and the temperature is greater than or equal to 125° F. However, it should be understood that the exact threshold of activation will vary based on the chemical components utilized as the reaction components. In additional embodiments, the reaction may proceed as a slow rate in basic or neutral conditions, but may dramatically accelerate in acidic conditions. For example, the reaction may be sufficient to reduce the viscosity of the tar over several hours in neutral or slightly basic conditions, but may sufficiently reduce the viscosity of the tar in several hours or less in acidic conditions.

The exothermic reaction components may be injected into the aqueous zone through an injection well. The injection may be continuous or in a bulk injection. The amount of exothermic reaction components injected and the rate of injection may be functions of the size of the aqueous zone, the desired temperature for the aqueous zone, and the exothermic reaction taking place. It is contemplated that sufficient tar viscosity reduction may be achieved in several hours following start of the exothermic reaction.

According to additional embodiments, the methods described presently which utilize an exothermic reaction may be coupled with the injection of other additives to the aqueous zone. For example, one or more of solvents, nano metals, ionic liquids, or basic additives may be utilized along with the exothermic reaction components. The use of such additives may contribute, along with the exothermic reaction, to mobilize the tar and effect pressure on the petroleum for extraction. Nano metals may include, for example, micron-sized metal particles that may improve the efficiency of tar mat viscosity reduction. Example of nano-metals include, without limitation, iron, iron oxide, nickel, and copper. Ionic liquids may include 1-ethyl-2,3-dimethylimidazolium tetrafluoroborate, 1-ethyl-3-methylimidazolium tetrafluoroborate, 1-butyl-3-methylimidazolium tetrafluoroborate, 1-butyl-2,3-dimethylimidazolium tetrafluoroborate. Basic additives may include sodium hydroxide, sodium metaborate. Example of nanofluids which may in included as additives include silicon oxide, aluminum oxide, and zirconium oxide. Contemplated solvents include xylene, benzene, cyclohexane, toluene, methylcyclohexane, isopropyl-benzene, decalin, tetralin, methylnaphthalenes, and mixtures of these.

In one or more embodiments, sweep efficiency may be improved by the methods presently disclosed. Sweep efficiency is a measure of the effectiveness of an enhanced oil recovery process that depends on the volume of the reservoir contacted by the injected fluid. The volumetric sweep efficiency is an overall result that depends on the injection pattern selected, off-pattern wells, fractures in the reservoir, position of gas-oil and oil/water contacts, reservoir thickness, permeability and areal and vertical heterogeneity, mobility ratio, density difference between the displacing and the displaced fluid, and flow rate. The mobilization by reduced viscosity of the tar may allow for enhanced sweep efficiency.

### EXAMPLES

The one or more examples presently provided should not be considered as limiting on the disclosed and presently claimed embodiments.

### Example 1

Exothermic reaction components were mixed and reacted in the presence of an asphaltene sample. Example 1 utilized a reaction mixture of 45 volumetric percent (vol. %) ammonium chloride, 45 vol. % sodium nitrite, and 10 vol. % acetic acid. This reaction mixture was mixed in a 1:1 volumetric ratio with asphaltene. This mixture was placed in a viscometer (made by Anton Paar) and stirring was applied. Viscosity was continuously measured while stirring and reaction activated. As the reaction activated, temperature started to increase and viscosity started to be reduced.

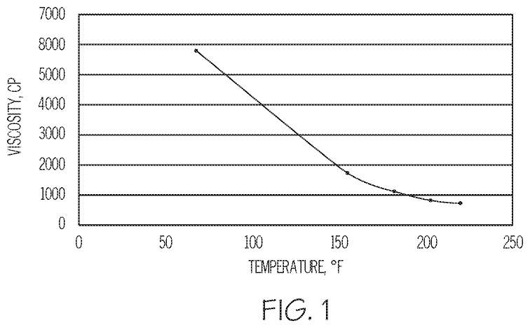

FIG. 1 depicts the viscosity and the temperature of the asphaltene sample during the reaction of the exothermic reaction components. Prior to mixing, the temperature of the asphaltene sample was approximately 60 degrees Fahrenheit (° F.) and the viscosity of the asphaltene sample was approximately 6,000 centipoise (cP). Upon the mixing of the exothermic reaction components, the sodium nitrite and the ammonium chloride underwent the exothermic reaction, producing heat and nitrogen gas. As the reaction progressed, the temperature of the asphaltene sample increased from approximately 50° F. to approximately 225° F. and the viscosity of the asphaltene sample decreased from approximately 6,000 cP to approximately 1,000 cP. That is, the reaction of sodium nitrite and ammonium chloride resulted in an increase of temperature and, as a result, a decrease in viscosity of asphaltene.

### Example 2

The effect of the exothermic reaction component volume on the exothermic reaction was measured. This example utilized a mixture of 50 vol. % sodium nitrate (3 molar concentration) and 50 vol. % ammonium chloride (3 molar concentration). The mixture was prepared and placed in a 3 liter autoclave reactor, commercially available as C-276 from Autoclave Engineers. The pressure was set to approximately 0 pounds per square inch (psi) and the temperature was increased by heating to approximately 120° F. until the reaction was triggered. The temperature and pressure change within the reactor was then measured approximately every 2 seconds for the duration of the reaction. This procedure was repeated twice: once with a 1 liter volume of exothermic reaction components and once with a 2 liter volume of exothermic reaction components.

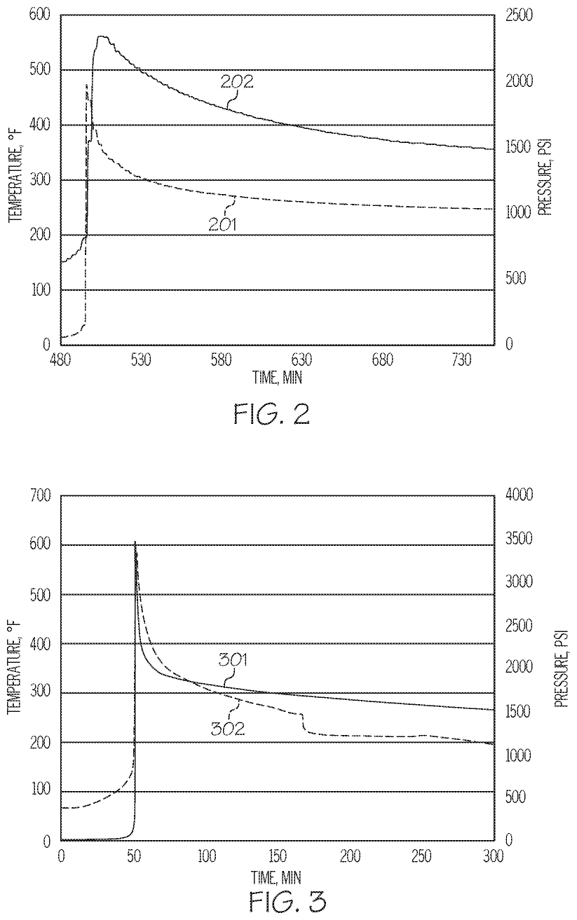

FIG. 2 depicts the change in temperature and the change in pressure within the reactor during the reaction 1 liter of volume of the exothermic reaction components. Line 201 represents the change in pressure. Line 202 represents the change in temperature. As shown by Line 201, the pressure within the reactor increased from approximately 0 psi to a maximum of approximately 2,000 psi during the reaction. Similarly, as shown by Line 202, the temperature within the reactor increased from approximately 150° F. to a maximum of approximately 550° F. during the reaction. FIG. 3 depicts the change in temperature and the change in pressure within the reactor during the reaction of 2 liters of the exothermic reaction components. Line 301 represents the change in pressure. Line 302 represents the change in temperature. As shown by Line 301, the pressure within the reactor increased from approximately 0 psi to a maximum of approximately 3,500 psi during the reaction. Similarly, as shown by Line 302, the temperature within the reactor increased from approximately 75° F. to a maximum of approximately 600° F. during the reaction. As such, an increase of 100% of the volume of the exothermic reaction components resulted in a nearly 10% increase in temperature and a nearly 75% increase in pressure. This may indicate that the pressure and temperature profiles generated by the exothermic reaction of the exothermic reaction components may be tailored to the downhole conditions of the reservoir by the increase or decrease of the volume of the exothermic reaction components.

### Example 3

The effect on the initial pressure of the reaction environment on the exothermic reaction of the exothermic reaction components was measured. The procedure as described in Example 2 was repeated twice, once with 1 liter of the exothermic reaction components at an initial pressure of 1,000 psi and once with 1 liter of the exothermic reaction components at an initial pressure of 1,855 psi.

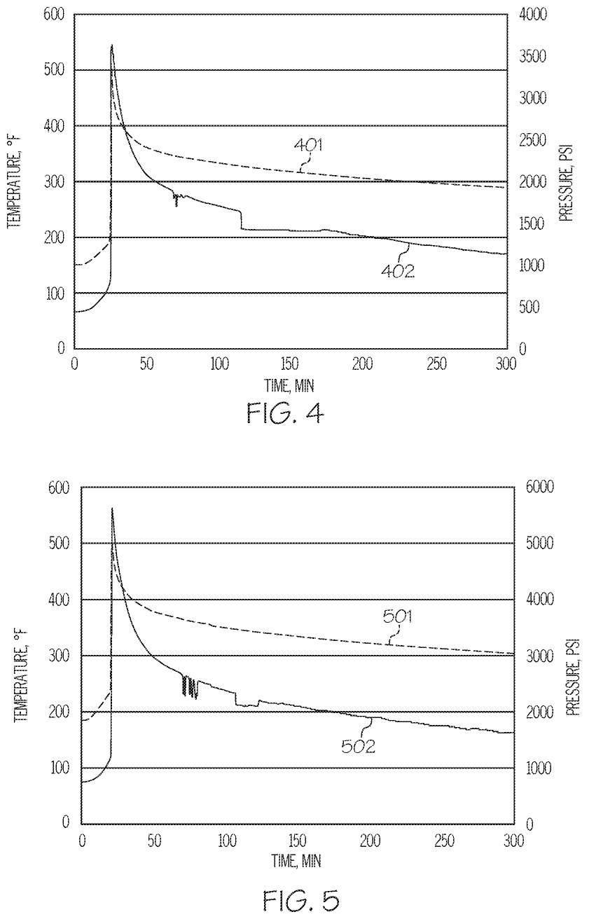

FIG. 4 depicts the change in temperature and the change in pressure within the reactor during the reaction with an initial pressure of 1,000 psi. Line 401 represents the change in pressure. Line 402 represents the change in temperature. As shown by line 401, the pressure within the reactor increased from approximately 1,000 psi to a maximum of approximately 3,500 psi during the reaction, an increase in pressure of 2,500 psi. As shown by line 402, the temperature within the reactor increased from approximately 75° F. to a maximum of approximately 550° F. during the reaction. FIG. 5 depicts the change in temperature and the change in pressure within the reactor during the reaction with an initial pressure of 1,855 psi. Line 501 represents the change in pressure. Line 502 represents the change in temperature. As shown by line 501, the pressure within the reactor increased from approximately 1,855 psi to a maximum of approximately 5,000 psi during the reaction, an increase in pressure of 3,145 psi. As shown by Line 502, the temperature within the reactor increased from approximately 75° F. to a maximum of approximately 550° F. during the reaction.

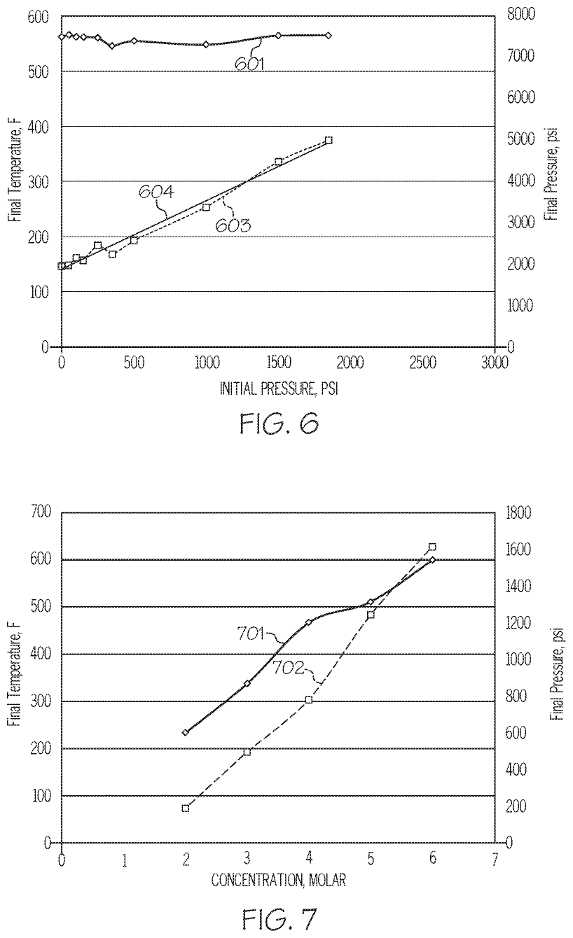

FIG. 6 plots the initial pressure of the exothermic reactions against the final achieved pressures and temperatures of the reactions. Line 601 represents the final achieved temperatures of the exothermic reactions. Line 603 represents the final achieved pressure of the exothermic reactions. Line 604 represents a linear regression fit line corresponding to the following linear regression equation:

P_{(Final)}=1.65×P_{(Initial)}+1887.3 EQUATION 1

where P_{(final)} is the final achieved pressure and P_{(Initial)} is the initial pressure of the reaction environment, for example, the downhole conditions of a reservoir in psi. This may indicate that the initial pressure of the reaction environment may directly result in an increase in the pressure generated by the exothermic reaction of the chemical reactants. However, as shown by Line 601, the initial pressure does not appear to have an effect on the temperature generated by the reaction. This may indicate that the pressure generated by the reaction of the thermochemicals may be variable and affected by the downhole conditions of the reservoir.

### Example 4

The effect of the exothermic reaction component concentration on the reaction of the exothermic reaction components was measured. The procedure as described in Example 2 was repeated five times with exothermic reaction components of varying concentrations, once each with concentrations of 2 moles per liter (M), 3 M, 4 M, 5 M, and 6 M. Due to the increased reactant concentration, the tested samples of Example 4 only utilized 100 milliliters of reactant solution.

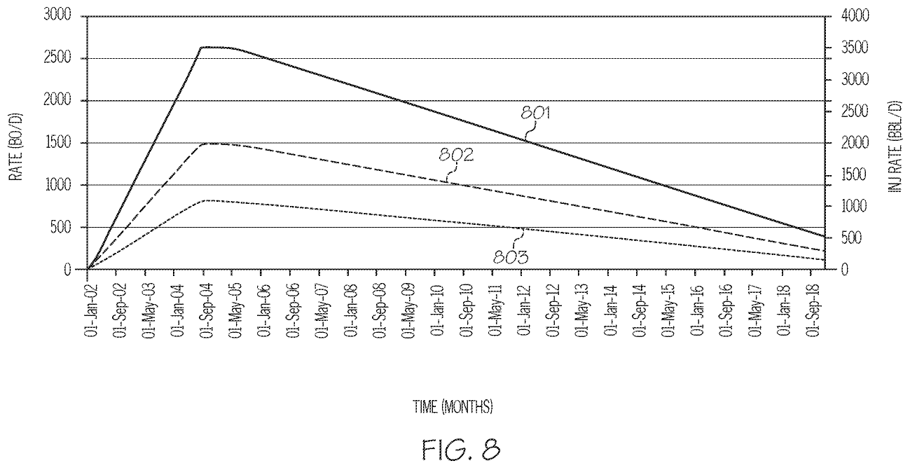

FIG. 7 plots the concentration of the exothermic reaction components against the final pressure achieved and the final temperature achieved during the reaction. Line 701 represents the temperature and line 702 represents the pressure. As shown by FIG. 7, both temperature and pressure increased fairly linearly with the increase of exothermic reaction component concentration. This may indicate that the pressure and temperature profiles generated by the reaction of the exothermic reaction components may be tailored to the downhole conditions of the reservoir by the increase or decrease of the concentration of the exothermic reaction components.

### Example 5

The production of oil resulting from the injection of exothermic reaction components was compared to the production of oil resulting from steam flooding. The valuation of downhole steam generation is based on the thermal heat generated. The reaction of the exothermic reaction components may generate approximately 144,000 kilojoules of heat per barrel (kJ/bbl) and steam flooding may generate approximately 80,000 kJ/bbl. That is, approximately 1 bbl of exothermic reaction components is equivalent to approximately 1.82 bbl of steam injected. In order to evaluate the efficiency and feasibility of the exothermic reaction components, data from steam flooding and calculations based of the same volume of exothermic reaction components was modeled and compared. The information for the oil field used to collect the data of the steam flooding is provided in Table 1.

TABLE 1

| | |
|---|---|
| Barrels of Steam Injected | 3,600 |
| (BSI PD) | |
| Oil API | 13° |
| Porosity | 43% |
| Permeability (Darcy) | 2 D |
| Space | 145 acres |
| Patterns | 7 Spot Inverted |
| Oil to Steam Ratio | 0.2 |
| (Assumption) | |
| Steam Quality (Assumption) | 75% |

FIG. 8 depicts a comparison of the barrels of oil that may be generated by the reaction of the exothermic reaction components and the barrels of oil generated by the steam flooding as described in Table 1. Line 801 represents the barrels injected per day (BBL/D) as shown on the right axis. Line 802 represents the barrels of oil generated per day (BO/D), as shown on the left axis, by the reaction of exothermic reaction components. Line 803 represents the barrels of oil generated per day by steam flooding. As shown by FIG. 8, the reaction of the exothermic reaction components within a reservoir result in a substantial increase of oil generated when compared to the same amount of steam. This indicates that the use of exothermic reaction components may be a superior alternative to steam flooding.

### Example 6

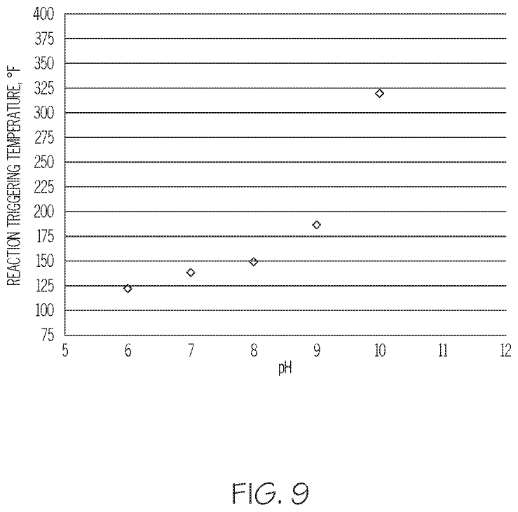

Example exothermic reactions were conducted to determine the relationship between the pH and the temperature necessary to trigger a reaction of the exothermic reaction components. Five solutions of the exothermic reaction components were prepared. The first solution had a pH of approximately 6, the second solution had a pH of approximately 7, the third solution had a pH of approximately 8, the fourth solution had a pH of approximately 9, and the fifth solution had a pH of approximately 10. The five solutions were placed in a reaction cell set at an initial pressure of 500 psi and gradually heated from room temperature until the exothermic reaction was triggered. The temperature at which the exothermic reaction of each solution triggered was then recorded. The results are graphically depicted in FIG. 9. These results indicate that the pH needed to trigger the reaction may, in at least some embodiments, is dependent on the temperature at the place of reaction, such as a downhole region.

It is noted that one or more of the following claims utilize the term “where” as a transitional phrase. For the purposes of defining the presently disclosed embodiments, it is noted that this term is introduced in the claims as an open-ended transitional phrase that is used to introduce a recitation of a series of characteristics of the structure and should be interpreted in like manner as the more commonly used open-ended preamble term “comprising.”

It will be apparent to those skilled in the art that various modifications and variations can be made to the presently disclosed embodiments without departing from the spirit and scope of the presently disclosed embodiments. Since modifications combinations, sub-combinations and variations of the disclosed embodiments incorporating the spirit and substance of the presently disclosed embodiments may occur to persons skilled in the art, the presently disclosed embodiments should be construed to include everything within the scope of the appended claims and their equivalents.

What is claimed is:

1. A method for recovering petroleum from a sub-surface reservoir, the method comprising:
passing one or more exothermic reaction components into an aqueous zone of the sub-surface reservoir in a geological formation, the sub-surface reservoir comprising the aqueous zone, a petroleum zone comprising petroleum, and an aqueous zone comprising water, where the petroleum zone and the aqueous zone are separated, at least partially, by the tar zone; and
reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface.

2. The method of claim 1, where following the exothermic reaction the pressure is increased in the petroleum zone.

3. The method of claim 1, where the reduction of the viscosity of the tar in the tar zone enhances fluid communication between the aqueous zone and the petroleum zone.

4. The method of claim 1, where the aqueous zone comprises water injected into the sub-surface reservoir from the surface.

5. The method of claim 1, where the aqueous zone comprises a naturally occurring aquafer.

6. The method of claim 1, where the one or more exothermic chemical reactants are passed into the aqueous zone through an injection well.

7. The method of claim 1, where prior to the exothermic reaction the aqueous zone has a greater pressure than the petroleum zone.

8. The method of claim 1, where following the exothermic reaction the aqueous zone is in direct contact with the petroleum zone.

9. The method of claim 1, where prior to the exothermic reaction the tar zone is in direct contact with the aqueous zone and the petroleum zone, and the aqueous zone and the petroleum zone are not in contact with one another.

10. The method of claim 1, where the one or more exothermic reaction components comprise an ammonium-containing compound and a nitrite-containing compound.

11. The method of claim 11, where the ammonium-containing compound is NH₄Cl and the nitrite-containing compound is NaNO₂.

12. The method of claim 1, where the exothermic reaction is activated by an acid precursor, the acid precursor selected from the group consisting of triacetin, methyl acetate, hydrochloric acid, acetic acid, and combinations of these.

13. The method of claim 1, where the exothermic reaction is activated by heat.

14. The method of claim 1, where a gas is released by the exothermic reaction.

15. The method of claim 18, where the exothermic reaction comprises the chemical reaction:
NH₄Cl+NaNO₂→N₂+NaCl+2H₂O+heat.

16. A method for recovering petroleum from a sub-surface reservoir, the method comprising:
passing one or more exothermic reaction components through an injection well and into an aqueous zone of the sub-surface reservoir in a geological formation, the reservoir comprising the aqueous zone, a petroleum zone comprising petroleum, and an aqueous zone comprising water, where the petroleum zone and the aqueous zone are separated, at least partially, by the tar zone; and
reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface through an extraction well.

17. The method of claim 16, where the one or more exothermic reaction components comprise an ammonium-containing compound and a nitrite-containing compound.

18. The method of claim 16, where following the exothermic reaction the pressure is increased in the petroleum zone.

19. A method for recovering petroleum from a sub-surface reservoir, the method comprising:
passing one or more exothermic reaction components into an aqueous zone of the sub-surface reservoir in a geological formation, the reservoir comprising the aqueous zone, a petroleum zone comprising petroleum, and an aqueous zone comprising water, where the petroleum zone and the aqueous zone are separated, at least partially, by the tar zone; and
reacting the one or more exothermic reaction components to increase the temperature, pressure, or both, in the aqueous zone to reduce the viscosity of the tar in the tar zone such that pressure in the aqueous zone may drive extraction of petroleum from the petroleum zone to the surface;
where the one or more exothermic reaction components comprise an ammonium-containing compound and a nitrite-containing compound; and
where the exothermic reaction is activated by an acid precursor.

20. The method of claim 19, where the exothermic reaction comprises the chemical reaction:
NH₄Cl+NaNO₂→N₂+NaCl+2H₂O+heat.
